(19) United States
(12) Patent Application Publication
(10) Pub. No.: US 2021/0289970 A1
(43) Pub. Date: Sep. 23, 2021

(54) SCROLL SPRING OF SCROLLING DEVICE FOR CURTAIN ASSEMBLY

(71) Applicant: Wen Xing Hu, Changhua County (TW)

(72) Inventor: Wen Xing Hu, Changhua County (TW)

(21) Appl. No.: 17/024,365

(22) Filed: Sep. 17, 2020

(30) Foreign Application Priority Data
Mar. 20, 2020 (CN) 202020367317.X

(51) Int. Cl. A47H 5/032; E06B 9/322; E06B 9/388; E06B 9/68

(52) U.S. Cl. CPC A47H 5/032; E06B 9/322; E06B 2009/6809; E06B 9/68; E06B 9/388

(57) ABSTRACT

A curtain assembly includes a scrolling device having a first axle, a second axle and at least one third axle. A scrolling spring is a scroll-shaped unit and includes a first end and a second end. The second end of the scrolling spring is located close to the center of the roll-shaped unit. The first end is located at outside of roll-shaped unit. The recovery force of the first end of the scrolling spring is smaller than that of the second end of the scrolling spring. The first end of the scrolling spring is connected to a first wheel. The second end of the scrolling spring is connected to a second wheel. The scrolling spring is wrapped in an “S” pattern between the first and second heels. When the curtain is collected, it does not expand downward. When the curtain is expanded, it is not dragged upward.

### BACKGROUND OF THE INVENTION

### 1. Fields of the Invention

The present invention relates to a scrolling device for a curtain assembly, and more particularly, to a scrolling spring of a scrolling device for a curtain assembly to stop or pull the curtain with sufficient scrolling force.

### 2. Descriptions of Related Art

The conventional scrolling device for a curtain assembly is disclosed in FIGS. 9 to 11, and includes a scrolling spring 40 which has a first end 41 and a second end 42. The first end 41 and the second end 42 of the scrolling spring 40 has the same scrolling force as shown in FIG. 11. When pulling the curtain, the bottom rail of the curtain is lowered from the position H0 to the position H3, and the weight of the curtain applied to the bottom rail is decreased from W0 to W3. Because the first end 41 and the second end 42 of the scrolling spring 40 has the same scrolling force, so that the pulling force of the scrolling device is F3 which is larger than the weight W3 of the curtain, so that the curtain retracts upward slightly.

Because the first end 41 and the second end 42 of the scrolling spring 40 has the same scrolling force, the scrolling spring 40 tends to reach its fatigue point soon. When the bottom rail is located at the position H0, the pulling force of the scrolling device is less than F3 which is less than the weight W0 so that curtain slides downward when collecting the curtain.

It is noted that the users have to use more force to pull the curtain down because the first end 41 and the second end 42 of the scrolling spring 40 has the same scrolling force. During the downward movement of the curtain, a portion of the curtain weight gradually shared by the top rail, the top rail shares the curtain weight from 0 to (W0-W3). The curtain weight reduces from W0 to W3, and the resilient force of the scrolling spring 40 still maintains the same. In order to overcome the resilient force of the scrolling spring 40, the users have to apply more force to pull the curtain downward as shown in FIG. 11.

FIGS. 12 and 13 shows another scrolling spring 40 which requires a large force during the first stage (H0-H1) of pulling the curtain, a medium force during the second stage (H1-H2), and a small force F2 during the second stage (H2-H3), as shown in FIG. 14. The second stage only requires the small force F2 so that the curtain does not bounce upward. The scrolling spring 40 includes three sections of three different radiuses, so that the scrolling spring 40 provides three stages of resilient forces.

However, there are two stress concentration points found in the scrolling spring 40 at the front portion and the rear portion of the middle section. The two stress concentration points cause the scrolling spring 40 to be deformed or even broken.

The present invention intends to provide a scrolling spring of a scrolling device for a curtain assembly to eliminate the shortcomings mentioned above.

### SUMMARY OF THE INVENTION

The present invention relates to a curtain assembly and comprises a scrolling device which comprises a seat that includes a first axle, a second axle and at least one third axle. A scrolling spring includes a first end, a second end and a body portion which is formed between the first and second ends. The scrolling spring is scrolled as a roll-shaped unit wherein the second end of the scrolling spring is located close to the center of the roll-shaped unit, and the first end is located at the outside of roll-shaped unit. The radius of the roll-shaped unit with respect to the first end of the scrolling spring is larger than that of the second end to the scrolling spring. The recovery force of the first end of the scrolling spring is smaller than that of the second end of the scrolling spring. The first end of the scrolling spring is connected to a first wheel that is mounted to the first axle. The body portion of the scrolling spring connecting the first end is wrapped at least one revolution of the first wheel. The second end of the scrolling spring is connected to a second wheel that is mounted to the second axle. The body portion of the scrolling spring connecting the second end is wrapped the second wheel. The scrolling spring is wrapped in an “S” pattern between the first and second wheels. The second end of the scrolling spring is stretched in an opposite direction to a scrolling direction of the roll-shaped unit of the scrolling spring when being wrapped to the second wheel. A top gear and a bottom gear are respectively connected to the top end and the bottom end of the second wheel.

A cord wheel unit is mounted to the at least one third axle and includes a cord wheel. A cord having a first end thereof is wrapped to the cord wheel. A driving gear is connected to at least one of the top end and the bottom end of the cord wheel. The driving gear is engaged with one of the top gear and the bottom gear of the second wheel. The second end of the cord extends through the curtain of the curtain assembly and is connected to a bottom rail.

When operating the bottom rail, the cord is operated to rotate the cord wheel. The driving gear drives one of the top gear and the bottom gear of the second wheel to rotate the second wheel, such that the scrolling spring is wrapped to the second wheel or the first wheel.

Preferably, the force required for operating the scrolling device and the weight of the curtain applied to the bottom rail are linearly changed in negative slopes, and substantially equal to each other, so that the curtain is positioned.

Preferably, the radius of the scrolling spring in the roll-shaped unit and the radius of the scrolling spring installed to the scrolling device are respectively changed linearly in positive slopes. The scrolling spring are smoothly wrapped to the first and second wheels when the curtain is moved upward and downward.

Preferably, the first end of the scrolling spring includes a plate formed thereto. The second end of the scrolling spring includes another plate formed thereto which is different in shape from the plate of the first end of the scrolling spring.

Preferably, the first end of the scrolling spring includes an elongate plate with a curved and convex side. The second end of the scrolling spring includes another plate which is an elongate plate with a curved and concave side.

The advantages of the present invention are that when the curtain is collected, the scrolling device provides a force that is larger than the weight of the curtain to prevent the curtain from dropping downward. The second end of the scrolling spring provides such force via the cord wheel.

When the curtain begins to expand downward, the user simply applies a force to the curtain downward, and the force from the user together with the weight of the curtain overcome the recovery force of the second end of the scrolling spring so that the curtain can be expanded.

During the process of lowering the curtain, the top rail shares a portion of the weight of the curtain, and the curtain applies less weight to the bottom rail, so that the scrolling spring warps to the second wheel via the release of the cord. The recovery force of the body of the scrolling spring gradually reduces so that the force from the scrolling device is able to stop and position the curtain at any desired position. The force from the scrolling device is substantially equal to the weight of the curtain, so that when the user releases the bottom rail, the curtain does not bounce upward or further expand downward.

The way of use of the scrolling device is similar to the conventional scrolling device. The recovery force of the first end of the scrolling spring is smaller than that of the second end of the scrolling spring. The scrolling spring is wrapped in an “S” pattern between the first and second wheels. The second end of the scrolling spring is stretched in an opposite direction to the scrolling direction of the roll-shaped unit of the scrolling spring when being wrapped to the second wheel. The scrolling device provides a linear force with a negative slope so that the user can operated the curtain by a stable force which saves effort.

The radius of the roll-shaped unit with respect to the second end of the scrolling spring is linearly increased toward the first end of the scrolling spring. Therefore, no stress concentration during operation of the scrolling spring.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the scrolling device of the present invention;

FIG. 2 shows that the scrolling device of the present invention is used to a curtain assembly;

FIG. 3 shows that the scrolling device of the present invention is used to another curtain assembly;

FIG. 4 is a perspective view to show the scrolling spring of the scrolling device of the present invention;

FIG. 5 shows that the scrolling spring of the scrolling device of the present invention is extended axially;

FIG. 6 shows that the scrolling spring is wrapped to the first wheel of the scrolling device of the present invention;

FIG. 6A shows the scrolling spring of the present invention is wrapped between the first and second wheels in an “S” pattern;

FIG. 7 is a chart to illustrate the change of the radius relative to the length of the scrolling spring of the present invention;

FIG. 8 is a chart to illustrate the change of the recovery force relative to the length of the scrolling spring of the present invention;

FIG. 9 shows that the conventional scrolling spring is axially expanded;

FIG. 10 shows the plan view of the conventional scrolling spring that is not yet scrolled;

FIG. 11 is a chart to illustrate the change of the recovery force of the conventional scrolling spring in FIGS. 9 and 10 relative to the length of the conventional scrolling spring in FIGS. 9 and 10, the height of the curtain and the weight of the curtain;

FIG. 12 is a chart to illustrate the change of the radius relative to the length of another conventional scrolling spring;

FIG. 13 is a chart to illustrate the change of the recovery force relative to the length of the another conventional scrolling spring;

FIG. 14 is a chart to illustrate the change of the recovery force of the another conventional scrolling spring relative to the length of the another conventional scrolling spring, the height of the curtain and the weight of the curtain;

FIG. 15 illustrates the scrolling spring of the present invention that tis expanded as a strip;

FIG. 15A illustrates the cross sectional of the scrolling spring of the present invention;

FIG. 16 shows that the scrolling spring of the present invention is wrapped between the first and second wheels; and

FIG. 17 is a chart to illustrate the change of the recovery force of the scrolling spring of the present invention relative to the length of the scrolling spring of the present invention, the height of the curtain and the weight of the curtain.

### DETAILED DESCRIPTION OF THE PREFERRED EMBODIMENT

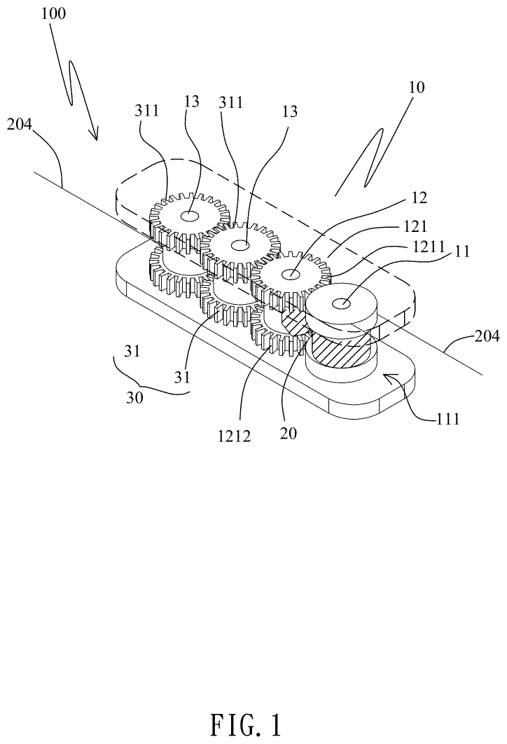

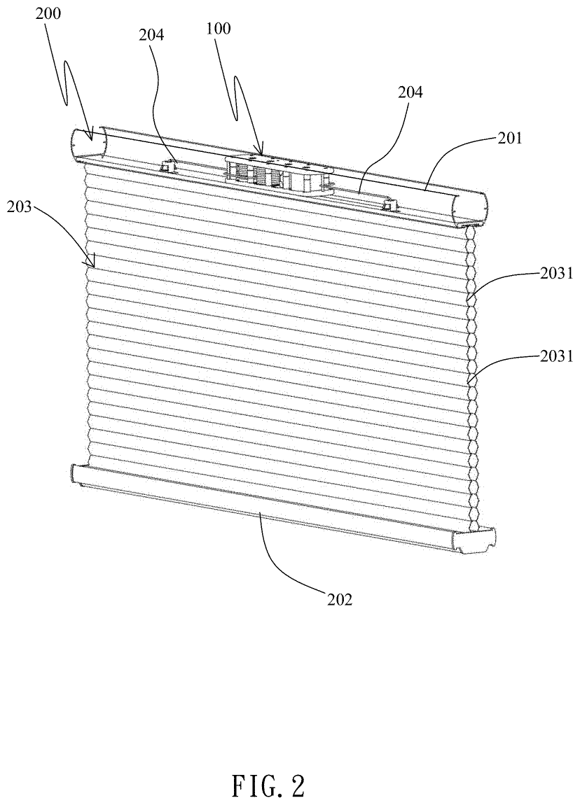

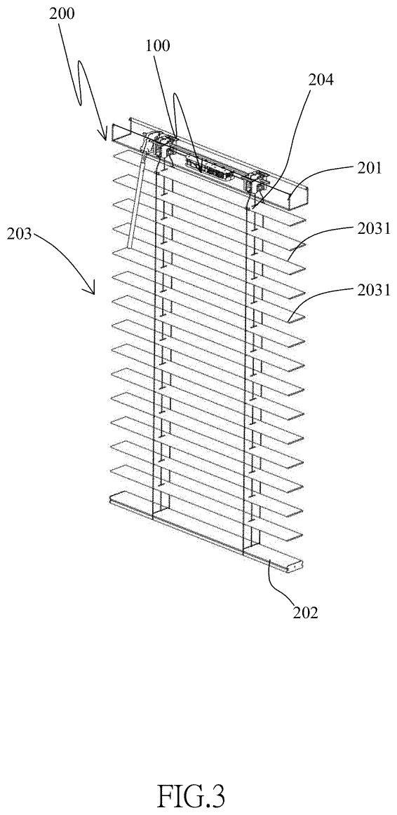

Referring to FIGS. 1 to 3, the scrolling device 100 of the present invention is installed to a cordless curtain assembly 200 which comprises a top rail 201, a bottom rail 202 and a curtain 203 composed of multiple slats 2031. The curtain assembly 200 is similar to the conventional ones, and includes at least one scrolling device 100. FIGS. 1-3 respectively disclose that the scrolling device 100 is used to different types of curtain assemblies.

The scrolling device 100 includes a seat 10, a scrolling spring 20 and a cord wheel unit 30.

The seat 10 includes a first axle 11, a second axle 12 and at least one third axle 13.

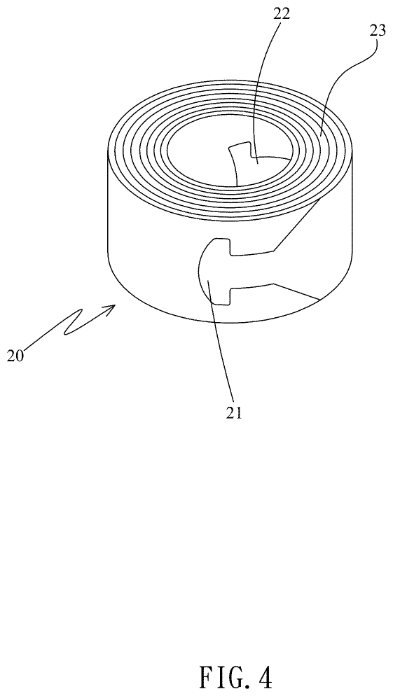

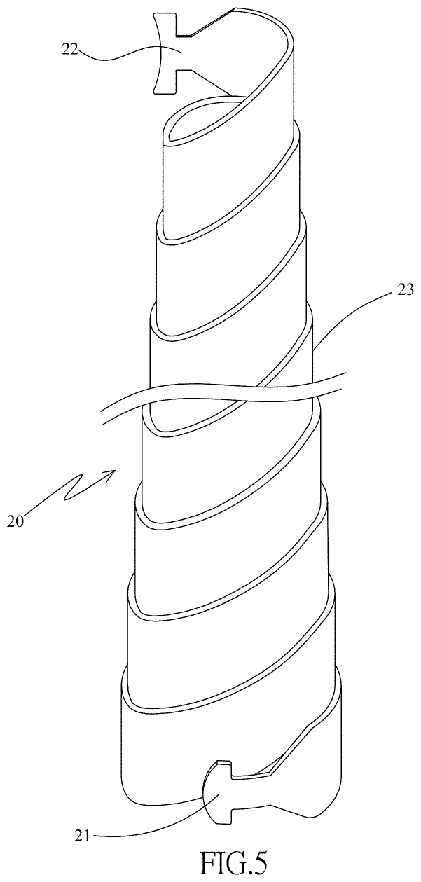

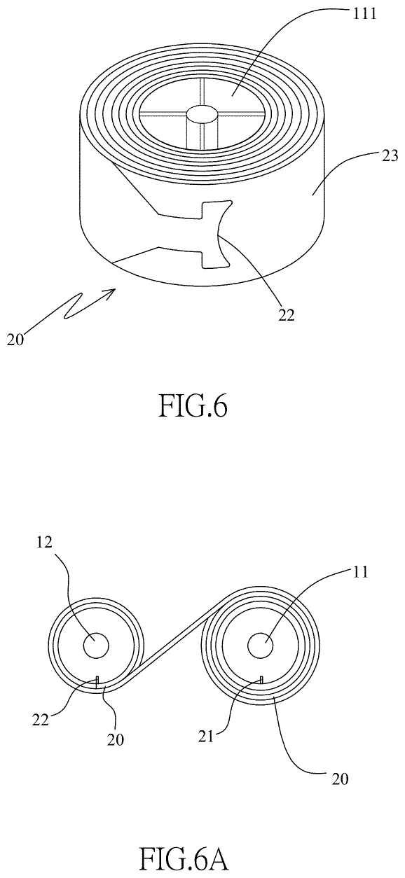

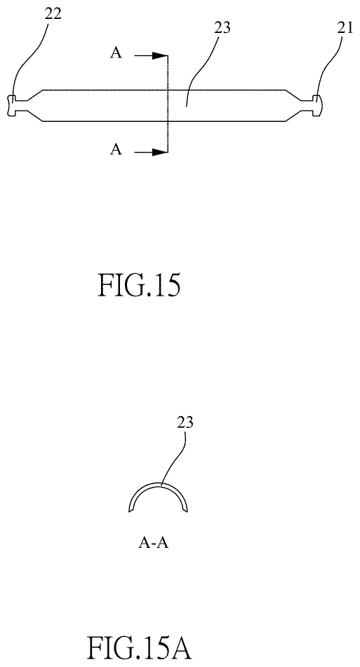

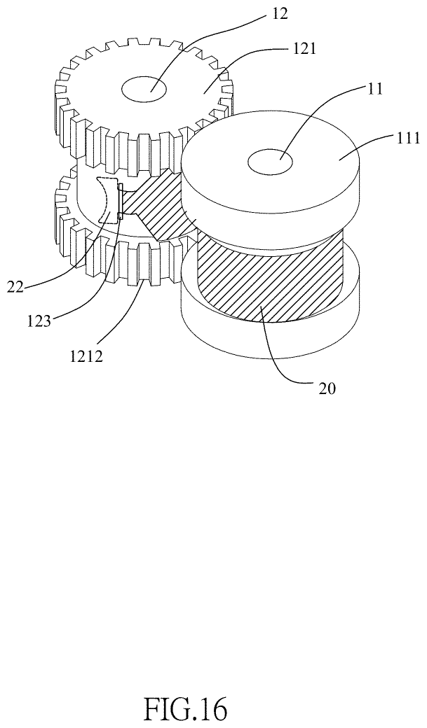

As shown in FIGS. 4, 5, 6, 6A, 15, 15A and 16 the scrolling spring 20 includes a curve cross section and has a first end 21, a second end 22 and a body portion 23 which is formed between the first and second ends 21, 22. The scrolling spring 20 is scrolled as a roll-shaped unit wherein the second end 22 of the scrolling spring 20 is located close to the center of the roll-shaped unit, and the first end 21 is located at outside of roll-shaped unit. The radius of the roll-shaped unit with respect to the first end 21 of the scrolling spring 20 is larger than that to the second end 22 of the scrolling spring 20. The recovery force of the first end 21 of the scrolling spring 20 is smaller than that of the second end 22 of the scrolling spring 20. The first end 21 of the scrolling spring 20 is connected to a first wheel 111 that is mounted to the first axle 11, and the body portion 23 of the scrolling spring 20 connecting the first end 21 is wrapped at least one revolution of the first wheel 111. The second end 22 of the scrolling spring 20 is connected to a second wheel 121 that is mounted to the second axle 12. The body portion 23 of the scrolling spring 20 connecting the second end 22 is wrapped the second wheel 121. It is noted that the scrolling spring 20 is wrapped in an “S” pattern between the first and second wheels 111, 121. The second end 22 of the scrolling spring 20 is stretched in an opposite direction to a scrolling direction of the roll-shaped unit of the scrolling spring 20 when being wrapped to the second wheel 121 as shown in FIG. 6A. A top gear 1211 and a bottom gear 1212 are respectively connected to the top end and the bottom end of the second wheel 121.

The cord wheel unit 30 is mounted to the at least one third axle 13 and includes a cord wheel 31, and a cord 204 has the first end thereof wrapped to the cord wheel 31. As shown in FIG. 1, a driving gear 311 is connected to at least one of the top end and the bottom end of the cord wheel 31. The driving gear 311 is engaged with one of the top gear 1211 and the bottom gear 1212 of the second wheel 121. The second end of the cord 204 extends through the curtain 203 of the curtain assembly 200 and is connected to the bottom rail 202. By lifting or pulling the bottom rail 202 to move the cord 204 to drive the cord wheel 31, the driving gear 311 drives one of the top and bottom gears 1211, 1212 to rotate the second wheel 121, so that the scrolling spring 20 is scrolled to the second wheel 121 or scrolled to the first wheel 111. When the user pulls the bottom rail 202, and a desired length of the cord 204 is released from the third axle 13. In the meanwhile, the scrolling spring 20 wraps around the second wheel 121 to keep the bottom rail 202 at that position and does not bounce upward.

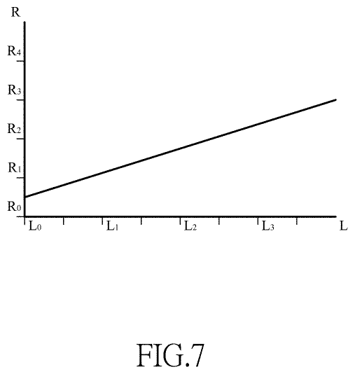

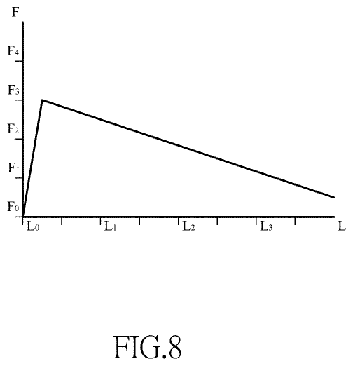

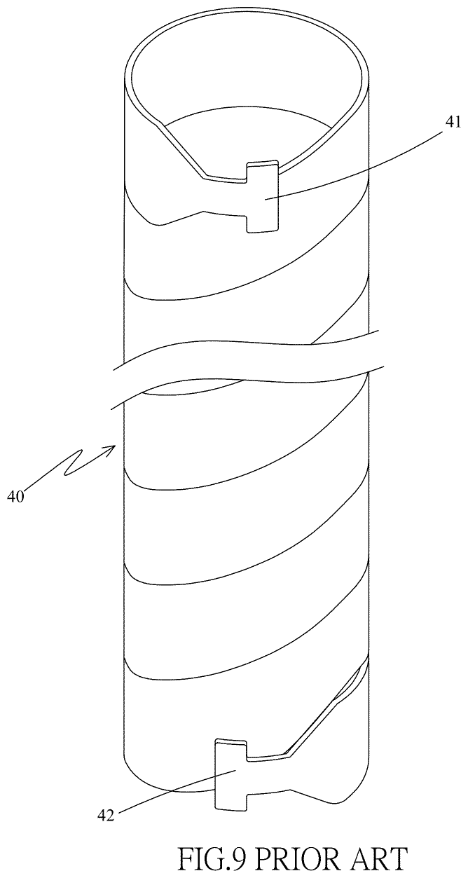

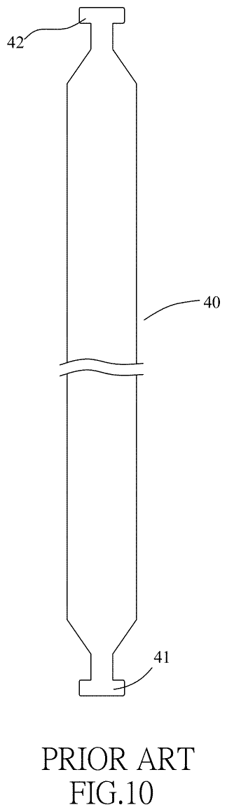

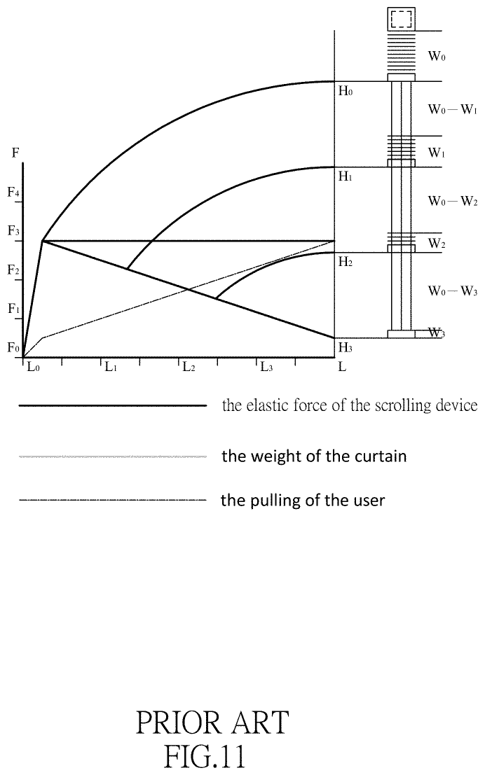

As shown in FIGS. 7 and 8, the first end 21 of the scrolling spring 20 includes an elongate plate with a curved and convex side, and the second end 22 of the scrolling spring 20 includes another plate which is an elongate plate with a curved and concave side. The radius of the roll-shaped unit with respect to the first end 21 of the scrolling spring 20 is larger than that to the second end 22 of the scrolling spring 20. The recovery force of the first end 21 of the scrolling spring 20 is smaller than that of the second end 22 of the scrolling spring 20. By the two plates of different shapes, the assembler can easily distinguish the first end 21 and the second end 22 of the scrolling spring 20, so that the scrolling spring 20 can be wrapped between the first and second wheels 111, 121 correctly.

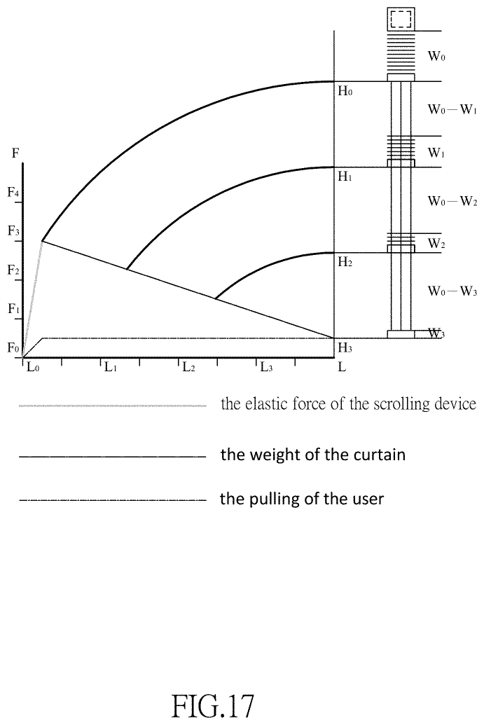

The advantages of the present invention are that, as shown in FIGS. 4 to 8, the scrolling spring 20 is wrapped between the first and second wheels 111, 121 in an “S” pattern as mentioned above. As shown in FIG. 17, when curtain 203 is lifted or lowered, the force required for operating the scrolling device 100 and the weight of the curtain 203 applied to the bottom rail 202 are linearly changed in negative slopes, and substantially equal to each other. When the user stops to apply force to the bottom rail 202, the curtain 203 stops at that position and the first wheel 111 does not rotate in opposite direction so that the second wheel 121 does not rotate the cord wheel 31 to pull the cord 204 back because of too much recovery force from the scrolling spring 20. Therefore, the curtain 203 does not bounce upward. Also, the weight applied to the bottom rail 202 is not larger than the pulling force from the scrolling device 100, so that the curtain 203 is lowered and stopped at that position.

As shown in FIG. 17, the user simply provides a stable and small force to operate the curtain assembly 200.

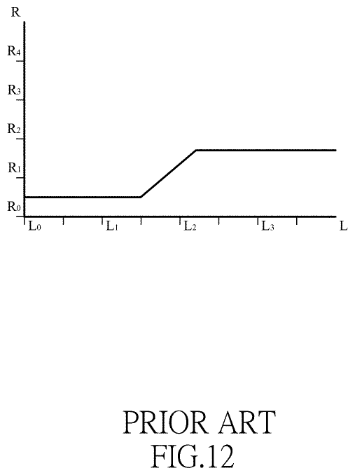

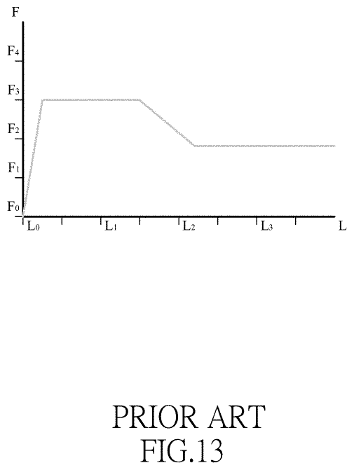

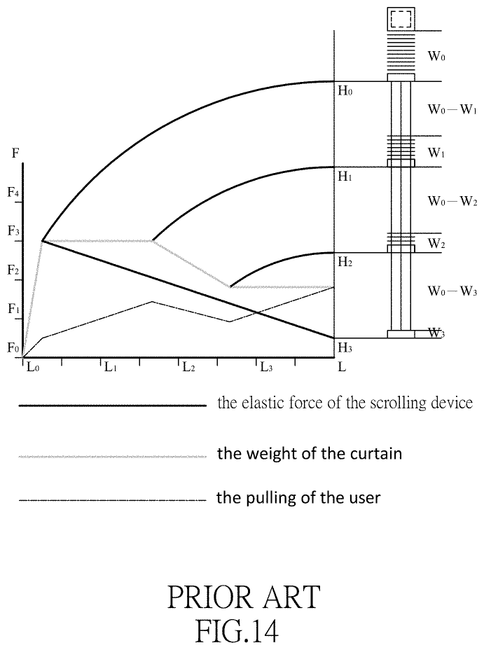

As shown in FIGS. 12 to 14, because the second conventional scrolling spring includes multiple radiuses which provide multiple levels of forces so that the second conventional scrolling spring has stress concentration at the transit area between two levels of forces, and the stress concentration easily damage the spring. On the contrary, as shown in FIGS. 4 to 8, the radius of the scrolling spring 20 in the roll-shaped unit and the radius of the scrolling spring 20 of the present invention installed to the scrolling device 100 are respectively changed linearly in positive slopes. Therefore, the scrolling device 200 has a linear force in negative slope which makes the scrolling spring 20 be wrapped between the first and second wheels 111, 121 smoothly. This ensures that the scrolling spring 20 has longer life and has a stable feature.

While we have shown and described the embodiment in accordance with the present invention, it should be clear to those skilled in the art that further embodiments may be made without departing from the scope of the present invention.

What is claimed is:

1. A curtain assembly comprising:
a scrolling device having a seat, the seat having a first axle, a second axle and at least one third axle, a scrolling spring including a first end, a second end and a body portion which is formed between the first and second ends, the scrolling spring being scrolled as a roll-shaped unit, the second end of the scrolling spring located close to a center of the roll-shaped unit, the first end located at an outside of roll-shaped unit, a radius of the roll-shaped unit with respect to the first end of the scrolling spring being larger than that to the second end of the scrolling spring, a recovery force of the first end of the scrolling spring being smaller than that of the second end of the scrolling spring, the first end of the scrolling spring being connected to a first wheel that is mounted to the first axle, the body portion of the scrolling spring connecting the first end being wrapped at least one revolution of the first wheel, the second end of the scrolling spring connected to a second wheel that is mounted to the second axle, the body portion of the scrolling spring connecting the second end being wrapped the second wheel, the scrolling spring being wrapped in an “S” pattern between the first and second wheels, the second end of the scrolling spring being stretched in an opposite direction to a scrolling direction of the roll-shaped unit of the scrolling spring when being wrapped to the second wheel, a top gear and a bottom gear respectively connected to a top end and a bottom end of the second wheel, and
a cord wheel unit mounted to the at least one third axle and including a cord wheel, a cord having a first end thereof wrapped to the cord wheel, a driving gear connected to at least one of a top end and a bottom end of the cord wheel, the driving gear engaged with one of the top gear and the bottom gear of the second wheel, a second end of the cord extending through a curtain of the curtain assembly and connected to a bottom rail, when operating the bottom rail, the cord is operated to rotate the cord wheel, the driving gear drives one of the top gear and the bottom gear of the second wheel to rotate the second wheel, such that the scrolling spring is wrapped to the second wheel or the first wheel.

2. The curtain assembly as claimed in claim 1, wherein a force required for operating the scrolling device and the weight of the curtain applied to the bottom rail are linearly changed in negative slopes, and substantially equal to each other, so that the curtain is positioned.

3. The curtain assembly as claimed in claim 2, wherein a radius of the scrolling spring in the roll-shaped unit and a radius of the scrolling spring installed to the scrolling device are respectively changed linearly in positive slopes.

4. The curtain assembly as claimed in claim 1, wherein the first end of the scrolling spring includes a plate formed thereto, the second end of the scrolling spring includes another plate formed thereto which is different in shape from the plate of the first end of the scrolling spring.

5. The curtain assembly as claimed in claim 1, wherein the first end of the scrolling spring includes an elongate plate with a curved and convex side, the second end of the scrolling spring includes another plate which is an elongate plate with a curved and concave side.
